(19) United States
(12) Patent Application Publication
(10) Pub. No.: US 2010/0277264 A1
(43) Pub. Date: Nov. 4, 2010

(54) SOLENOID

(76) Inventors: John Clifford Charnley, Newcastle Upon Tyne (GB); Clinton Eugene Sheppard, Mountain Home, AR (US)

Correspondence Address: QUARLES & BRADY LLP, 411 E. WISCONSIN AVENUE, SUITE 2040, MILWAUKEE, WI, 53202-4497, US

(21) Appl. No.: 12/738,202

(22) PCT Filed: Sep. 30, 2008
(86) PCT No.: PCT/GB08/50883

§ 371 Date: Jul. 15, 2010

Related U.S. Application Data
(60) Provisional application No. 60/999,320, filed on Oct. 16, 2007.

(30) Foreign Application Priority Data
May 27, 2008 (GB) 0809542.4

(51) Int. Cl. H01F 7/08; E05B 47/02

(52) U.S. Cl. 335/234; 70/277

(57) ABSTRACT

A solenoid assembly (1) is disclosed, the solenoid having a first electro-magnet (9) for producing a first magnetic field. There is also movable element (3), in the form of a permanent magnet (4), with flux guides (7,8) to distribute the magnetic field, which moves within the magnetic field created by the electro-magnet. A second electro-magnet (11) may also- be included in the solenoid thereby creating a push-pull solenoid. The second electro-magnet is arranged so that its magnetic field acts in the opposite direction to the first electro-magnet by having its coils wound in the opposite direction.

The present invention relates to an improved solenoid. Although the present invention has applications in numerous areas of technology such as locking devices and power tools, the present invention is particularly, but not exclusively suitable for use in the medical field, most notably in the fields of biomechanics, heart assist devices, replacement hearts, portable ventilators and wound pressure application.

Solenoids are well known in the art. A known solenoid typically comprises a helically wound electrically conductive coil capable of inducing a magnetic field when an electric current flows therethrough, along with a movable ferrous plunger arranged so that it is able to move axially through the centre of the coil. A solenoid typically further comprises a ferrous plunger stop at or near one end of the coil, along with a ferrous shell disposed radially outwardly of the coil and plunger assembly.

When electric current flows through the coil, a magnetic field is induced, which causes the ferrous plunger to move longitudinally through the centre of the coil, towards the plunger stop. The magnitude of the force applied to the ferrous plunger as a result of the magnetic field is dependent upon the magnitude of the electric current in the coil and also the position of the plunger with respect to the plunger stop. In particular, for a constant electric current flowing in the coil, as the plunger moves towards the stop (and thereby reduces the air gap), the force applied to the plunger increases exponentially. This exponential increase in force as the plunger moves towards the stop is not always convenient for all applications. However, known methods for minimizing the exponential nature of the increase in the force applied to the plunger can also disadvantageously reduce the actual magnitude of the force applied to the plunger.

It is to be appreciated that the direction of motion of the ferrous plunger in such known solenoids is always to reduce the air gap between the plunger and the plunger stop. As a result, such known solenoids are inherently “pull” actuators, whereby the plunger may be attached to an external mechanism, and when electric current flows through the coil, the plunger exerts a pulling force on the external mechanism. In the event however, that it is required to exert a pushing force on an external mechanism, the plunger and the plunger stop may be modified by way of attaching a push rod to the plunger and providing the plunger stop with an aperture through which the push rod can move freely when electric current flows through the coil. With this arrangement, the push rod is able to exert a pushing force on an external mechanism as the plunger moves towards the plunger stop when electric current flows through the coil.

Despite being a useful means of providing both a push force and a pull force, this arrangement suffers from the disadvantage that there is a reduction in the magnitude of the force which may be applied to the plunger as a result of the magnetic field, and the requirement for an aperture in the plunger stop.

Preferred embodiments of the present invention seek to overcome the above described problems with the prior art.

According to an aspect of the present invention there is provided a solenoid assembly comprising:
(i) first electro-magnet means for producing a first magnetic field in response to an electric current; and
(ii) at least one movable element disposed adjacent said first electro-magnet means for movement in response to electric current flowing through said first electro-magnet means,
   wherein at least one said movable element comprises at least one permanent magnet.

Preferably, at least one said first electro-magnet means comprises at least one first electrically conductive coil having a first end and a second end.

In having a movable element comprising at least one permanent magnet, this provides the advantage that there is always at least one magnetic pole within at least one said first electrically conductive coil, with the result that if the direction of the electric current through the first electrically conductive coils is reversed, then the movable element moves in an opposite direction. Conversely, with known solenoids having a conventional ferrous movable element, if the direction of electric current is reversed once the movable element has reached the stop, then the movable element does not then move in the opposite direction and instead remains at rest. In having a solenoid assembly in which the movable element is able to move in either direction simply by means of reversing the direction of the electric current, this provides the advantage that the solenoid assembly is bi-directional and further, the magnitude of the pushing force applicable to an external mechanism is substantially the same as the magnitude of the pulling force applicable to an external mechanism.

Preferably, at least one said movable element further comprises at least one first flux guide disposed adjacent a first end of said permanent magnet and at least one second flux guide disposed adjacent a second end of said permanent magnet.

Said solenoid assembly may further comprise a further movable element disposed end to end with said movable element.

The solenoid may further comprise a ferrous shell disposed radially outwardly of, and at least partially overlapping with, at least one said first electrically conductive coil.

This provides the surprising advantage that the magnetic flux density in the electrically conductive coils remains constant for all locations of the movable element inside the coils. In view of this, and in view of the fact that the magnitude of the force applied to the movable element is dependent upon the magnitude of the electric current flowing through the coils, then for a constant electric current, the force applied to the movable element also remains constant over the allowable movement of the movable element through the coils. Conversely, in conventional solenoids, the force applied to the movable element increases exponentially as the movable element moves through the coils and towards the stop.

In having flux guides at each end of the permanent magnet, this provides the further advantage that a magnetic flux permeable path offering low resistance to the magnetic field is provided. This in turn provides a means for minimizing the length of the air gaps through which the magnetic flux must pass. In this way, the length of the air gap is the radial distance from the outer surface of the flux guides to the inner surface of the ferrous shell.

Preferably, the solenoid assembly further comprises at least one second electro-magnet means for producing a second magnetic field in response to an electric current.

In a preferred embodiment at least one said second electro-magnet means comprises at least one second electrically conductive coil having a first end and a second end, whereby said first end of at least one said second electrically conductive coil is disposed adjacent the second end of at least one said first electrically conductive coil, wherein said movable element is movable through said electrically conductive coils in a direction between said first end of at least one said first electrically conductive coil and said second end of at least one said second electrically conductive coil in the event that electric current flows through at least one of said first and second electrically conductive coils.

In another preferred embodiment said coils are disposed such that electric current is able to flow in one of a clockwise or anticlockwise direction through at least one said first electrically conductive coil, and in the other of a clockwise or anticlockwise direction through at least one said second electrically conductive coil.

At least one said second electrically conductive coil may be electrically connected to at least one said first electrically conductive coil.

The permanent magnet may comprise a mild steel elongate element.

The solenoid may further comprise a ferrous shell disposed radially outwardly of and at least partially overlapping with, said first and second electrically conductive coils.

In some circumstances it is desirable to adapt the solenoid assembly so that the magnitude of the force does not remain substantially constant over the allowable movement of the movable element, but instead increases substantially linearly as a function of the position of the movable element within the first and second coils. In order to achieve this, the coil winding density of the electrically conductive coils may be such that the coil winding density increases from the first end of at least one said first electrically conductive coil to said second end of at least one said second electrically conductive coil.

According to another aspect of the present invention there is provided a solenoid assembly comprising: —
(i) first electro-magnet means for producing a first magnetic field in response to an electric current;
(ii) second electro-magnet means for producing a second magnetic field in response to an electric current;
(iii) at least one movable member disposed adjacent said first and second electro-magnet means for movement in response to electric current flowing through said first and/or second electro-magnet means wherein at least one said first and second electro-magnet means are disposed such that the first and second magnetic fields act in substantially opposite directions.

In a preferred embodiment at least one said first electro-magnet means comprises at least one first electrically conductive coil having a first end and a second end, and at least one said second electro-magnet means comprises at least one second electrically conductive coil having a first end and a second end.

Preferably, at least one said first and second electrically conductive coils are arranged such that the first end of at least one said second electrically conductive coil is disposed adjacent the second end of at least one said first electrically conductive coil.

In a preferred embodiment at least one said first and second electrically conductive coils are arranged such that electric current flows in one of a clockwise or anticlockwise direction through at least one said first electrically conductive coil and in the other of a clockwise or anticlockwise direction through at least one said second electrically conductive coil.

This provides the advantage that the forces applied to the movable element by the first and second electrically conductive coils are additive.

The solenoid assembly may further comprise at least one third electrically conductive coil disposed adjacent said first end of said at least one first electrically conductive coil, and at least one fourth electrically conductive coil disposed adjacent said second end of said at least one second electrically conductive coil.

Preferably, at least one said first, second, third and fourth electrically conductive coils are arranged so that electric current flows through at least one said third electrically conductive coil in an opposite sense to at least one said first electrically conductive coil, and so that electric current flows through at least one said fourth electrically conductive coil in an opposite sense to at least one said second electrically conductive coil.

It is preferable that the solenoid assembly further comprises a first ferrous stop adjacent at least one said third electrically conductive coil, and a second ferrous stop adjacent at least one said fourth electrically conductive coil.

This provides the advantage that electric current is only required to be switched on for a portion of the operating time of the solenoid assembly, thereby reducing operational costs. This provides the further advantage that a high holding force is generated at either end of the solenoid assembly, in view of magnetic latching between the movable member and the first and second ferrous stops. In this way, the solenoid assembly is substantially stable to vibration and/or impact.

According to a further aspect of the present invention there is provided a solenoid assembly comprising: —
(i) at least one first electrically conductive coil for producing a first magnetic field, wherein at least one said first electrically conductive coil is disposed such that electric current flows therethrough in a first sense;
(ii) at least one second electrically conductive coil for producing a second magnetic field wherein at least one said second electrically conductive coil is disposed such that electric current flows therethrough in a second sense opposite said first sense; and
(iii) at least one movable member disposed adjacent said first and second coils.

According to a further aspect of the present invention there is provided a lock comprising a solenoid assembly as previously described.

Preferred embodiments of the present invention will now be described, by way of example only and not in any limitative sense, with reference to the accompanying drawings in which: —

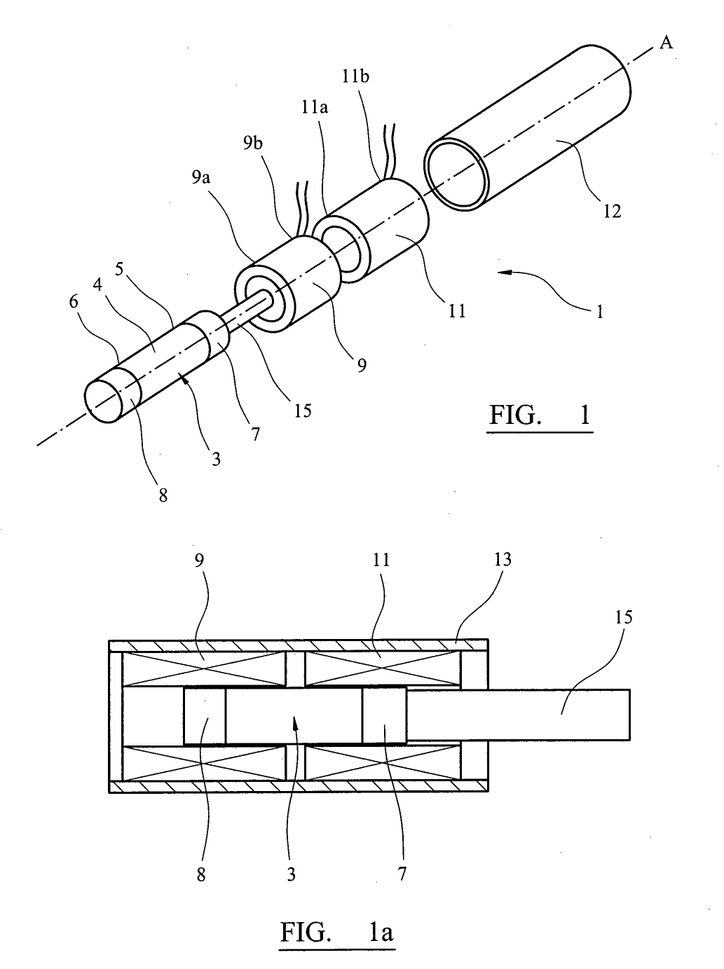

FIG. 1 shows an exploded perspective view of a solenoid assembly in accordance with an embodiment of the present invention;

FIG. 1a shows a cross-sectional view of the solenoid assembly of FIG. 1, additionally showing a push and pull rod;

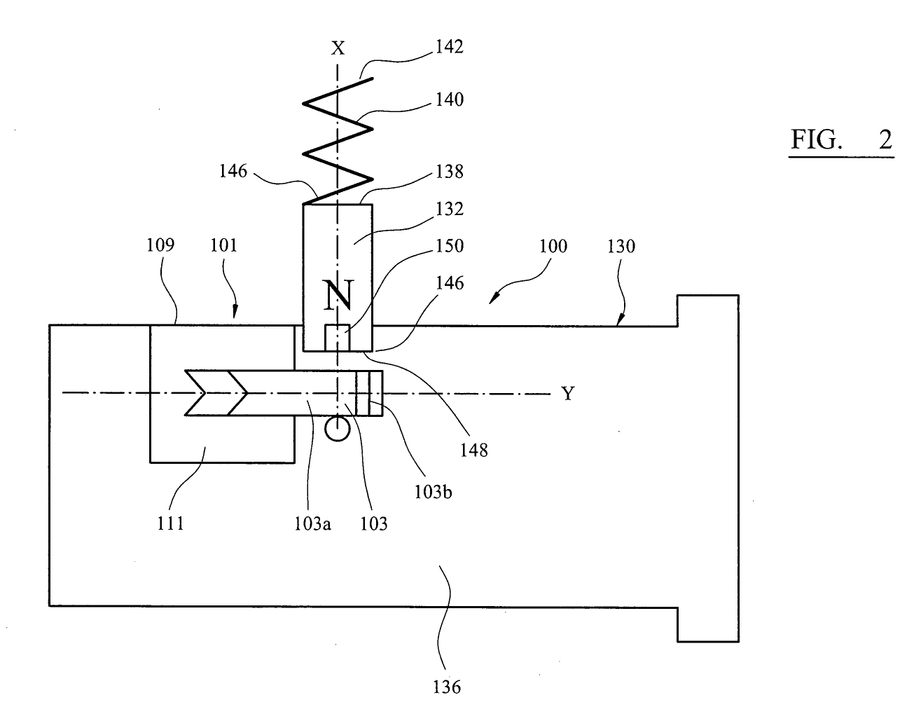

FIG. 2 shows a cross sectional view of a first embodiment of a lock incorporating a solenoid assembly in accordance with an embodiment of the present invention, in a locking configuration;

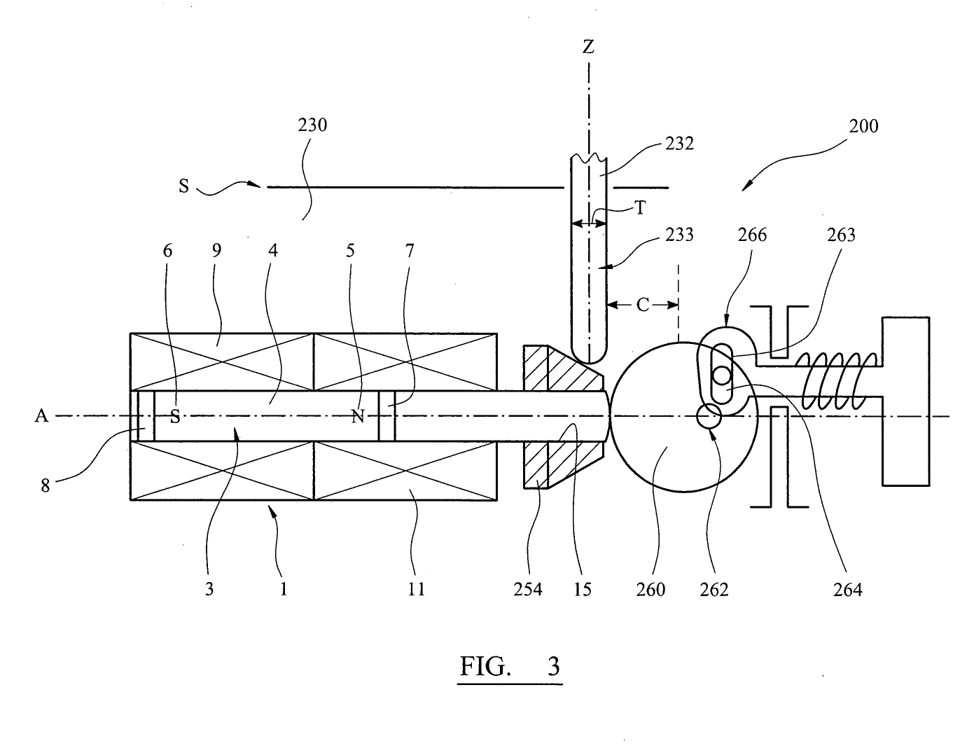

FIG. 3 shows a cross sectional view of a further embodiment of a lock incorporating the solenoid assembly of FIG. 1, in a locking configuration;

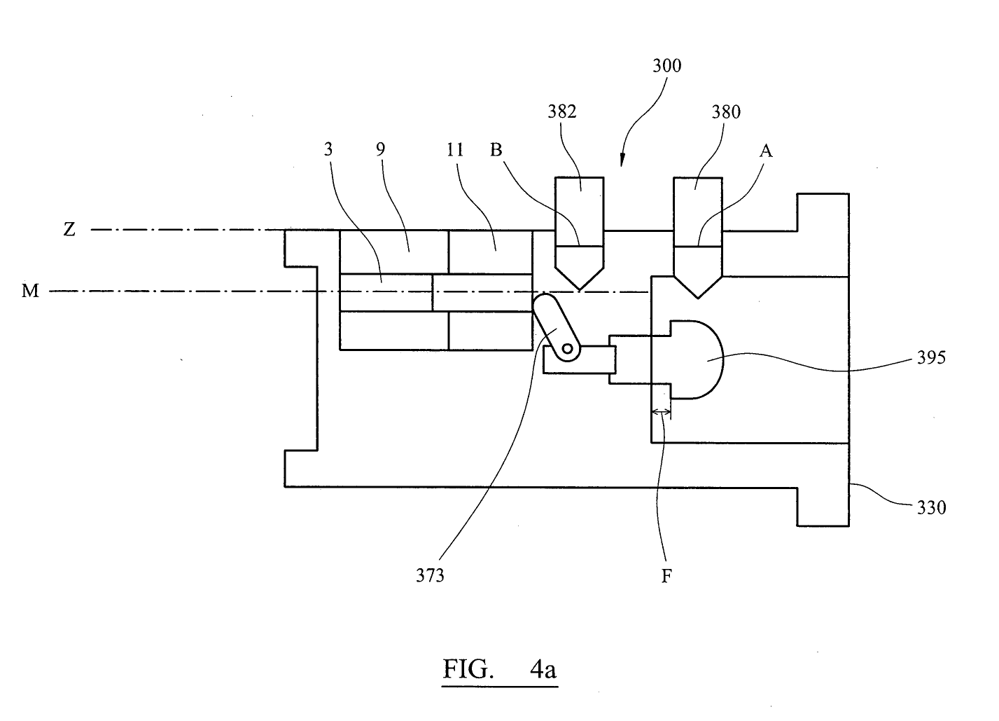

FIG. 4a shows a cross sectional view of a further embodiment of a lock incorporating the solenoid assembly of FIG. 1, in a locking configuration;

FIG. 4b shows a cross sectional view of the lock of FIG. 4a in an unlocking configuration;

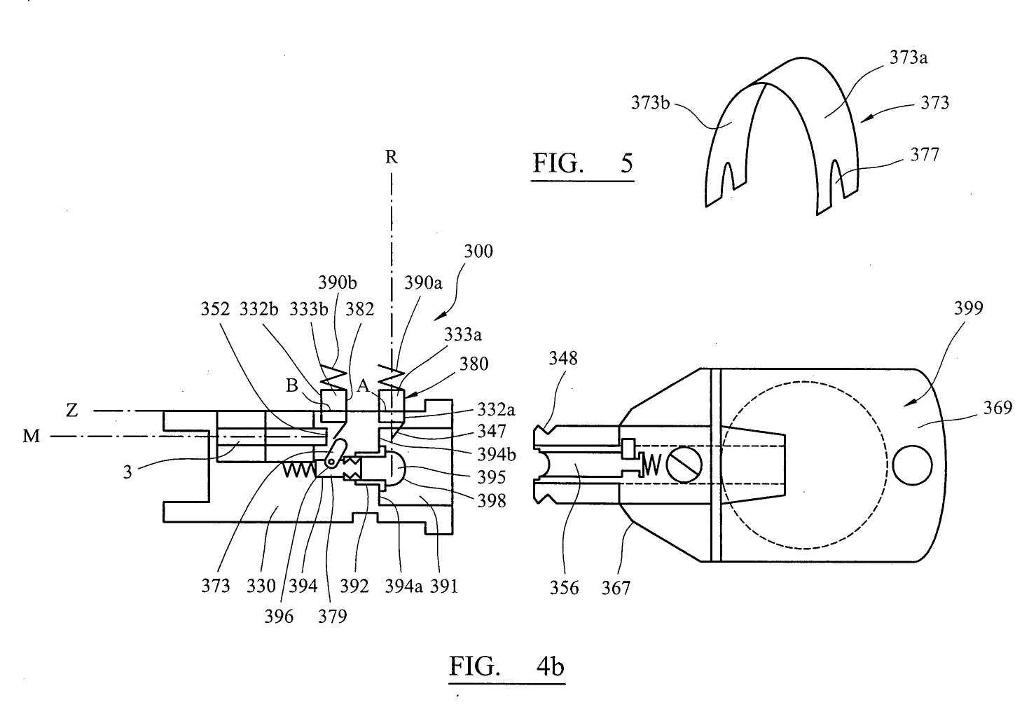

FIG. 5 shows a perspective view of a U-shaped pivot element forming a part of the lock of FIGS. 4a and 4b;

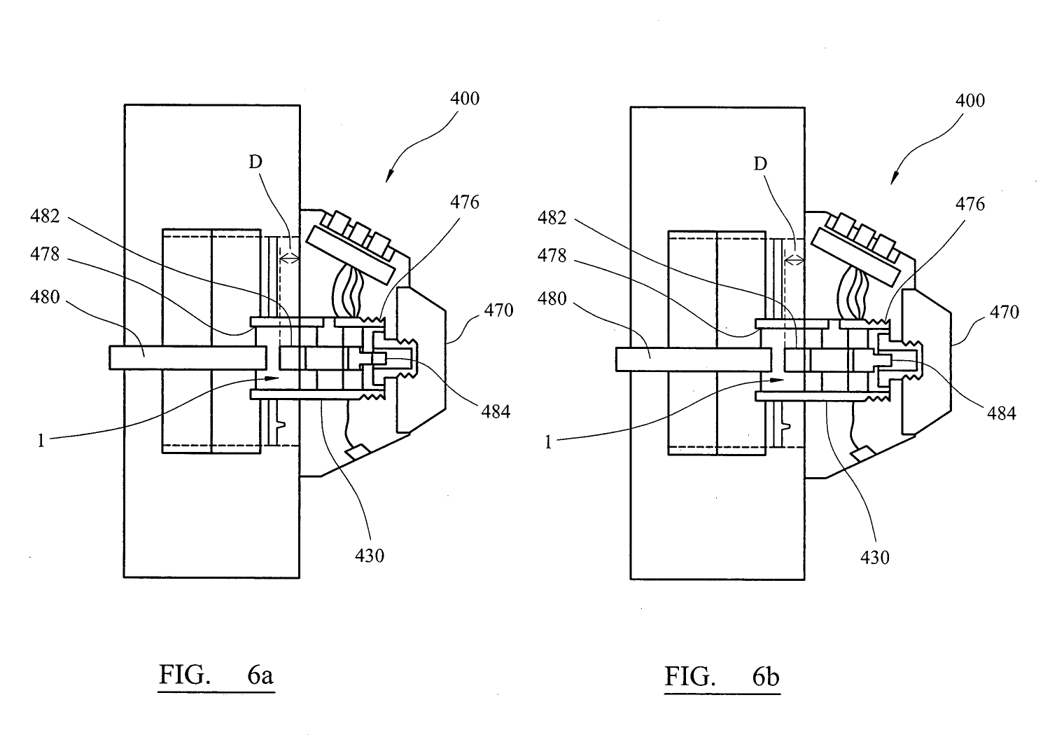

FIG. 6a shows a cross sectional view of a further embodiment of a lock incorporating the solenoid assembly of FIG. 1, in a locking configuration;

FIG. 6b shows a cross sectional view of the lock of FIG. 6a in an unlocking configuration;

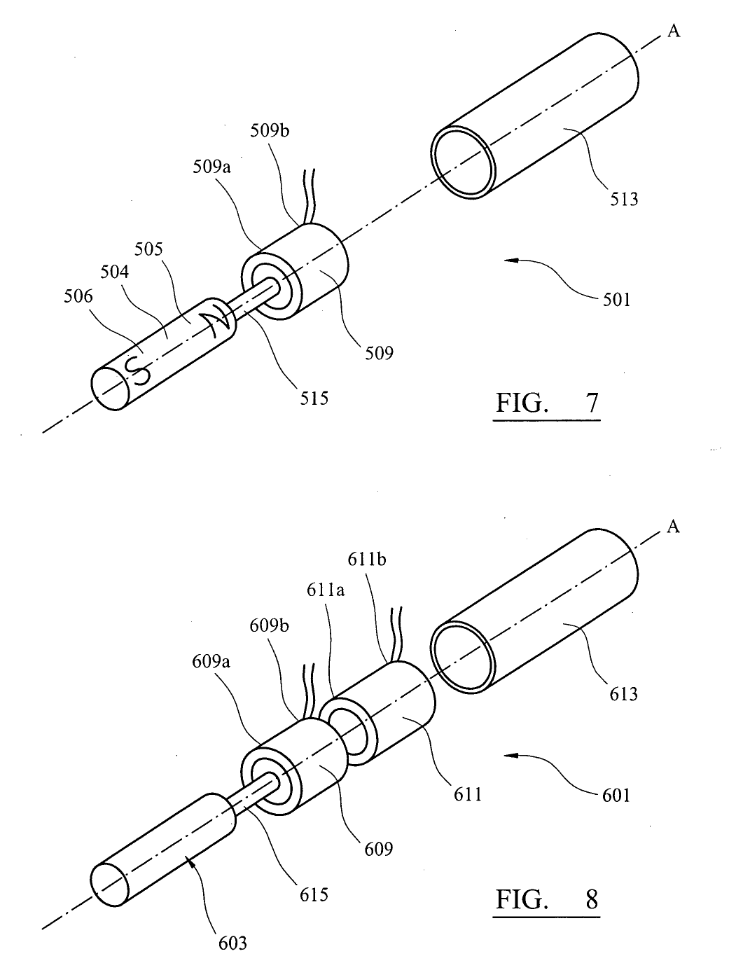

FIG. 7 is a perspective view of an embodiment of a solenoid assembly of the present invention;

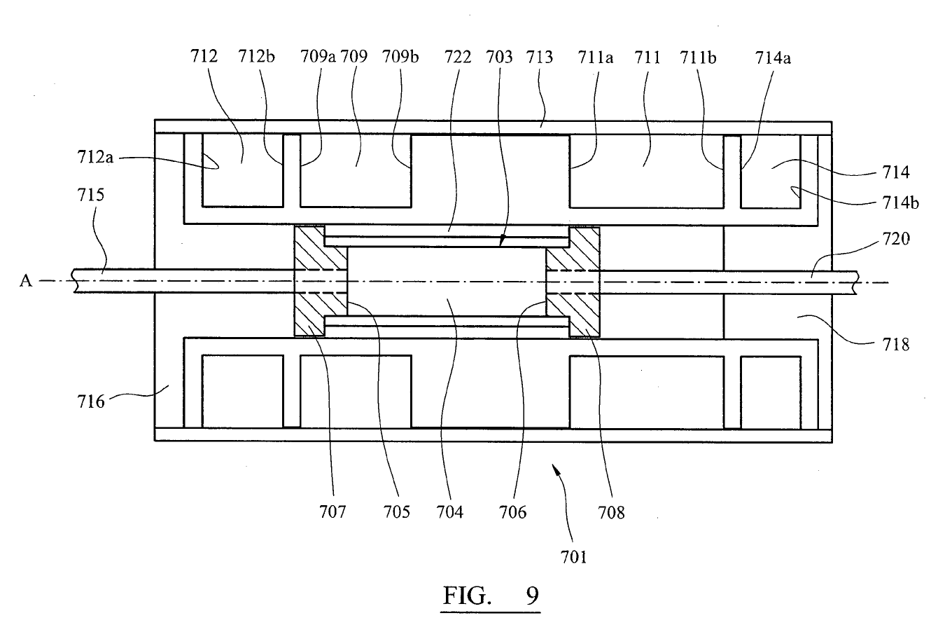

FIG. 8 is a perspective view of another solenoid assembly of the present invention; and

FIG. 9 is a cross-sectional view of a solenoid assembly in accordance with a further embodiment of the present invention.

With reference to FIGS. 1 and 1a, a solenoid assembly is represented generally by reference numeral 1. The solenoid assembly 1 comprises a movable element 3 comprising a permanent magnet 4 having a north pole 5 and a south pole 6, along with a first ferrous flux guide 7 attached to the north pole 5 of the permanent magnet 4 and a second ferrous flux guide 8 attached to the south pole 6 of the permanent magnet 4.

The solenoid assembly 1 further comprises a first electrically conductive coil 9 having a first end 9a and a second end 9b, and a second electrically conductive coil 11 having a first end 11a and a second end 11b. The first and second coils 9 and 11 are arranged with the windings of their respective coils in opposite directions. In other words, the first coil 9 is wound in an anticlockwise direction and the second coil 11 is wound in a clockwise direction. It is to be appreciated that the opposing magnetic fields are created by the electric current flowing in an anticlockwise direction through the first coil 9, and flowing in a clockwise direction through the second coil 11 irrespective of whether the wire of the coils is wound clockwise or anticlockwise. As can be clearly seen from FIG. 1, the longitudinal axis A passes through the centre of both the first coil 9 and the second coil 11, and in this way, the first 9 and second 11 coils are aligned with each other and are disposed end to end.

The solenoid assembly 1 further comprises a ferrous shell 13 disposed radially outwardly of the coils 9 and 11.

The flux guides 7 and 8 provide a flux permeable path offering low resistance to the magnetic field, which provides a means for minimizing the length of the air gaps through which the magnetic flux must pass. By using the flux guides 7 and 8, the length of the air gap is the radial distance from the outside surface of the flux guides 7 and 8 to the inside surface of the ferrous shell 13.

The movable element 3 is disposed such that it is free to move in a direction through the first 9 and second 11 electrically conductive coils in the event that electric current flows through the coils 9 and 11. It is to be appreciated that the movable element 3 is able to move either in a direction from the first end 9a of the first electrically conductive coil 9 to the second end 11b of the second electrically conductive coil 11, or in an opposite direction from the second end 11b of the second electrically conductive coil 11 to the first end 9a of the first electrically conductive coil 9, depending upon the direction of flow of electric current through the coils 9 and 11. The coils 9 and 11 may be connected either in series or in parallel. The solenoid assembly 1 further comprises a push and pull rod 15, which is disposed at one end of the movable element 3, adjacent the north pole 5.

The solenoid assembly 1 functions as follows. A magnetic field is established by the permanent magnet 4, and the resulting lines of magnetic flux flow in complete paths through the permanent magnet 4, the flux guides 7 and 8, the coils 9 and 11, and the ferrous shell 13. A further magnetic field is also established when electric current flows through the coils 9 and 11. As a result, when electric current is passed through the coils 9 and 11, the movable element 3 moves through the coils 9 and 11 in a direction from left to right as shown in FIG. 1.

In view of the fact that the direction of flow of the electric current through the first coil 9 is anticlockwise and that the flow of electric current through the second coil 11 is clockwise, the forces applied to the movable member 3 by the magnetic fields generated by the coils 9 and 11 are additive. Moreover, the direction of the force applied to the movable member 3 as a result of the interaction of the magnetic fields established by the permanent magnet 4 and the electric current flowing through the coils 9 and 11, is substantially parallel to the longitudinal axis A and is dependent on the direction of flow of the electric current through the coils 9 and 11. In view of this, reversing the direction of the electric current flowing through each of the coils 9 and 11 reverses the direction of the force exerted upon the movable element 3. In view of this, the solenoid assembly 1 is able to exert both a pulling force and a pushing force on external devices, and this will be described in further detail below.

The push and pull rod 15 may be connected to an external device and facilitates the function of the solenoid assembly 1 as either a push actuator or a pull actuator depending upon the direction of flow of electric current through the coils 9 and 11.

The push and pull rod 15 is preferably made from a non magnetic material so that it does not alter the magnetic flux path. It may be made from any suitable material including but not limited to some forms of stainless steel, brass, zinc, aluminum and plastic.

The magnitude of the force exerted on the movable element 3 is dependent upon, and is directly proportional to, the strength of the magnetic field in the coils 9 and 11 as a result of the permanent magnet 4 and the electric current flowing through the coils 9 and 11. The magnetic flux density in the coils 9 and 11 as a result of the permanent magnet 4 is a constant for all positions of the movable element 3 within the coils 9 and 11. Accordingly, for constant electric current flowing through the coils 9 and 11, the force exerted on the movable element 3 is constant over the allowable movement of the movable element 3.

Although in this configuration, the magnitude of the force applied to the movable element 3 remains substantially constant over the allowable movement of the movable element 3 (as discussed above), the solenoid assembly 1 can instead be adapted to provide a force which changes as a function of the position of the movable element 3 within the coils 9 and 11. This is achieved by altering the number of turns on the coils 9 and 11 between the cylindrical outer surface of the flux guides 7 and 8 and the inner surface of the ferrous shell 13. For example, if the coils 9 and 11 are wound in such a way that the number of turns on the coils 9 and 11 per unit length (the winding density) increases linearly over the entire length of the coils 9 and 11, then as the movable element 3 moves through the coils 9 and 11, the force applied to the movable element 3 increases as the number of turns per unit length increases. In view of this, the winding density in both coils 9 and 11 can be altered as required to yield virtually any desired relationship between the force applied to the movable element 3 and the position of the movable element 3.

Referring now to FIG. 2, in which parts in common with FIG. 1 have been given like reference numerals increased by 100, a lock 100 is shown, which incorporates a solenoid assembly 101, a cylinder plug 130, a driver pin 132, and a compression spring 140.

The solenoid assembly 101 comprises a movable element 103 comprising a soft iron rod 103a having a rare earth magnet 103b disposed at one end thereof. The solenoid assembly 101 further comprises first 109 and second 111 electrically conductive coils, whereby the first coil 109 is wound in an anticlockwise direction and the second coil 111 is wound in a clockwise direction.

The cylinder plug 130 is disposable in a suitable aperture (not shown) in a door. As can be clearly seen from FIG. 2, the longitudinal axis X of the driver pin 132 is substantially perpendicular to the longitudinal axis Y of the movable element 103 of the solenoid assembly 101.

At a first end 138 of the driver pin 132 is disposed the compression spring 140 which is attached at one end 142 to the interior of a door for example, and is attached at a second end 144 to the driver pin 132. The compression spring 140 is disposed so as to bias the driver pin 132 into engagement with an aperture 146 in the cylinder plug 130. At a second end 148 of the driver pin 132 is disposed a rare earth magnet 150.

The lock 100 operates as follows.

With reference to FIG. 2, in the event that no electric current flows through the coils 109 and 111, the force applied by the compression spring 140 maintains the driver pin 132 in a position of engagement with the aperture 146 in the cylinder plug 130 to prevent rotation of the cylinder plug 130. The engagement of the driver pin 132 with the aperture 146 is further facilitated by the attraction of the soft iron element 103a to the rare earth magnet 150, and as a result of this, even in the event that no electrical current flows through the coils 109 and 111, the driver pin cannot be easily moved in a direction out of engagement with the aperture 146 in order to facilitate the rotation of the cylinder plug 130.

In the event however, that electric current flows through the coils 109 and 111, the movable element 103 moves in a direction to the left as shown in FIG. 2. As a result of this, the rare earth magnet 103b moves to a position such that it is directly underneath the rare earth magnet 150. In view of this, the two magnets 103b and 150 repel each other, thereby overcoming the biasing force of the compression spring 140 and causing the driver pin 132 to move out of engagement with the aperture 146 to allow the cylinder plug 130 to be rotated.

In the event that the electric current is switched off again, the movable element 103 and hence the driver pin 132 remain in the same position, until a reversed electric current is switched on again after a pre-determined period of time, whereupon the movable element 103 moves in a direction to the right as shown in FIG. 2, with the result that the rare earth magnet 150 is attracted to the soft iron element 103a, to bring the driver pin 132 back into engagement with the aperture 146 and thereby preventing the cylinder plug 130 from rotating once again.

Referring now to FIG. 3, a further embodiment of a lock 200 is shown, which incorporates a solenoid assembly 1, disposed within a cylinder plug 230. The lock 200 further comprises a driver pin 232 and a differ pin 233, whereby the driver pin 232 and the differ pin 233 are disposed end to end and substantially aligned with each other. The driver pin 232 and differ pin 233 are each biased downwardly as shown in FIG. 3 by means of a compression spring (not shown). The lock 200 further comprises a disk 260 eccentrically mounted for rotation about a pin 262, whereby the disk 260 includes a nub 263 which is engageable with an aperture 264 of a key 266.

The solenoid assembly 1 is similar to that described with reference to FIG. 1, and comprises a movable element 3 comprising a permanent magnet 4 having a north pole 5 and a south pole 6, along with a first flux guide 7 attached to the north pole 5 of the permanent magnet 4 and a second flux guide 8 attached to the south pole 6 of the permanent magnet 4.

The solenoid assembly 1 further comprises a first electrically conductive coil 9 and a second electrically conductive coil 11, whereby the first coil 9 is wound in an anticlockwise direction and the second coil 11 is wound in a clockwise direction. The movable element 3 is disposed such that it is free to move in a direction through the first 9 and second 11 electrically conductive coils in the event that electric current flows through the coils 9 and 11. It is to be appreciated that the movable element 3 is able to move either in a direction from left to right or from right to left as shown in FIG. 3, depending upon the direction of flow of electric current through the coils 9 and 11.

The solenoid assembly 1 further comprises a push and pull rod 15, which is disposed at one end of the movable element 3, adjacent the north pole 5. The push and pull rod is connected to a differ cam 254.

The longitudinal axis A of the solenoid assembly is substantially perpendicular to the longitudinal axis Z of both the driver pin 232 and differ pin 233.

The lock 200 operates as follows.

In the event that no electric current flows through the coils 9 and 11, the movable element 3 remains in the position shown in FIG. 3, whereby the interface T between the driver pin 232 and differ pin 233 is not aligned with the shear line S between the cylinder plug 230 and the door.

In the event however, that the key 266 is pushed into the lock 200; that is, in a direction towards the left as shown in FIG. 3, the eccentrically mounted disk 260 rotates about the pin 262 with the result that a measure of clearance C for the differ cam 254 is provided. The next time that electric current flows through the coils 9 and 11, the movable element 3 moves in a direction towards the right as shown in FIG. 3b, over the clearance distance C. As a result of the tapered profile of the differ cam 254, this movement of the movable element 3 from the left to the right urges both the differ pin 232 and the driver pin 233 in an upwardly direction as shown in FIG. 3, with the result that the interface T between the driver pin 232 and the differ pin 233 is aligned with the shear line S. In view of this, the cylinder plug 230 is able to be rotated.

In the event that the key 266 is subsequently pulled in a direction towards the right, the eccentrically mounted disk 260 rotates with the result that the movable element 3 is urged in a direction towards the left as shown in FIG. 3. It is to be appreciated that this is the case whether or not there is electric current flowing through the coils 9 and 11. In view of the fact that the driver pin 232 and differ pin 233 are mounted so that they are biased downwardly, as the movable element 3 is urged towards the left, the shear line S and the interface T are no longer aligned, with the result that the lock 200 returns to its locking position as shown in FIG. 3. In this way, the lock is always in its locking position when the key 266 is not present.

The lock 200 further includes a processor (not shown), which is able to selectively control the flow of electric current through the coils 9 and 11.

Referring now to FIGS. 4a and 4b, a further embodiment of a lock 300 is shown, which incorporates a solenoid assembly 1, disposed within a cylinder plug 330. The lock 300 further comprises a first pin set 380 and a second pin set 382. The first pin set 380 comprises a first driver pin 332a and a first differ pin 333a, and the second pin set 382 comprises a second driver pin 332b and a second differ pin 333b, whereby in each pin set 380, 382, the driver pins 332a and 332b and the differ pins 333a and 333b are disposed end to end and substantially aligned with each other. The interface between the pins 332a and 333a is represented by reference numeral A and the interface between the pins 332b and 333b is represented by reference numeral B. In each of the pin sets 380 and 382, the driver pins 332a and 332b and the differ pins 333a and 333b are each biased downwardly by means of compression springs 390a and 390b respectively.

The cylinder plug 330 includes a first recessed portion 391, a second recessed portion 392, and a third recessed portion 394, with shoulders 394a and 394b defining the interface between the first 391 and second 392 recessed portions. The cylinder plug 330 further includes a first movable element 396 that is connected to a second movable element 398 having an enlarged end 395 at its distal end. The first movable element 396 together with the second movable element 398 are able to move in a direction from left to right and vice versa and are only limited in their movement by the presence of the shoulders 394a and 394b.

The lock 300 further comprises a U-shaped pivot element 373, which is shown in more detail in FIG. 5. The U-shaped element 373 comprises two legs 373a and 373b, each leg 373a and 373b having a slot 377 formed therein. The first movable element 396 comprises two pins 379 on opposite sides thereof, and the U-shaped pivot element 373 is mounted on the first movable element 396 by means of the slots 377 being located over the pins 379.

The solenoid assembly 1 is similar to that described with reference to FIG. 1, and comprises a movable element 3 comprising a permanent magnet 4 having a north pole 5 and a south pole 6, along with a first flux guide 7 attached to the north pole 5 of the permanent magnet 4 and a second flux guide 8 attached to the south pole 6 of the permanent magnet 4.

The solenoid assembly 1 further comprises a first electrically conductive coil 9 and a second electrically conductive coil 11, whereby the first coil 9 is wound in an anticlockwise direction and the second coil 11 is wound in a clockwise direction. The movable element 3 is disposed such that it is free to move in a direction through the first 9 and second 11 electrically conductive coils in the event that electric current flows through the coils 9 and 11. It is to be appreciated that the movable element 3 is able to move either in a direction from left to right or from right to left, depending upon the direction of flow of electric current through the coils 9 and 11.

As can be seen from FIG. 4a, when the lock 300 is in its inoperative position, with no key present in the lock 300 and no electric current flowing through the electrically conductive coils 9 and 11, there is a measure of clearance F between the enlarged end 395 and the shoulders 394a and 394b. Moreover, the U-shaped pivot element is disposed towards the left with the result that the movable element 3 of the solenoid is prevented from moving to the right. Moreover, the interfaces A and B are not aligned with the shear line Z between the cylinder plug 330 and the door interior, with the result that the cylinder plug 330 is prevented from rotating.

The lock 300 further incorporates a key 399 having a key blade 367 and a key bow 369. The key blade 367 comprises a shaped distal end 356 which is shaped so that it is able to locate over the enlarged end 395. As can be seen from FIG. 4b, when the key 399 is inserted into the first recessed portion 391, the distal end 356 of the key 399 (which is shaped such that it locates over the enlarged end 395) abuts against the first driver pin 332a on the first pin set 380 and urges the first pin set 380 in an upwardly direction, with the result that the interface A between the first driver pin 332a and the first differ pin 333a is aligned with the shear line Z between the cylinder plug 330 and the interior of the door.

The first driver pin 332a has a chamfered end 347 which fits inside a correspondingly shaped notch 348 in the key blade 367 when the key 399 has been pushed into the first recessed portion 391. The location of the chamfered end 347 in the notch 348 serves to ensure that in the event that the key 399 is rotated, the cylinder plug 330 also rotates.

In addition to urging the first pin set 380 in an upward direction as described above, the introduction of the key 399 into the first recessed portion 391 additionally serves to urge the first 396 and second 398 movable elements to the left, which results in the U-shaped pivot element 373 pivoting about the pins 379 to cause the top of the U-shaped pivot element 373 to move to the right so that it is in the position shown in FIG. 4b. In view of this movement of the top of the U-shaped pivot element 373 to the right, there is a measure of clearance provided to facilitate the movement of the movable member 3 to the right so that it is in the position as shown in FIG. 4b.

Accordingly, once the key 399 is inserted into the first recessed portion 391 and electric current begins to flow through the first 9 and second 11 coils, the movable element 3 is able to move to the right. Such movement of the movable element 3 to the right causes the end of the movable element 3 having the first flux guide 7 to contact the chamfered end 352 of the second driver pin 332b, to urge the second pin set 382 in an upwardly direction. This upwardly movement of the second pin set 382 results in the interface 13 between the second driver pin 332b and the second differ pin 333b aligning with the shear line Z between the cylinder plug 330 and the interior of the door, to facilitate rotation of the cylinder plug 330 in the event that the key 399 is rotated.

In the event that the key 399 is pulled out of the first recessed portion 391, then once again, the first 396 and second 398 movable elements together move to the right in view of the biasing action of the compression spring 342, with the result that the U-shaped pivot element 373 urges the movable member 3 to the left. In view of this movement of the movable member 3 to the left, the compression spring 390b urges the second pin set 382 in a downwardly direction, with the result that the interface B between the second driver pin 332b and the second differ pin 333b is no longer aligned with the shear line Z between the cylinder plug 330 and the interior of the door. In addition, as the key 399 is removed from the first recessed portion 391, the first pin set 380 is pushed in an upwardly direction against the bias of the compression spring 390a and then is urged back down again when the key 399 has been completely removed from the first recessed portion 391, with the result that the interface A between the first driver pin 332a and the first differ pin 333a is no longer aligned with the shear line Z between the cylinder plug 330 and the interior of the door.

It is to be appreciated that the longitudinal axis M of the solenoid assembly 1 is substantially perpendicular to the longitudinal axis R of the first 380 pin set.

The lock 300 further includes a processor (not shown), which is able to selectively control the flow of electric current through the coils 9 and 11.

Referring now to FIGS. 6a and 6b, a further embodiment of a lock 400 is shown, which incorporates a solenoid assembly 1 disposed within a cylinder plug 430 having a first end 476 and a second end 478. The lock 400 further comprises a turn knob 470 which is rotatably mounted on the first end 476 of the cylinder plug 430, and a latch bar 480 non-rotatably mounted on the second end 478 of the cylinder plug 430. As can be clearly seem from the Figures, a rear face of the turn knob 470 includes a first rebate 484.

As can be clearly seen from the Figures, the solenoid assembly 1 is disposed within the interior of the cylinder plug 430, and the second end 478 of the cylinder plug 430 includes a second rebate 482, inside of which the movable member 3 of the solenoid assembly 1 locates. The depth D of the rebate 482 is such that the movable member 3 locates in the rebate 482 whether the movable member 3 is in its position to the right as shown in FIG. 6b (i.e. the lock 400 is in its unlocking condition), or its position to the left as shown in FIG. 6a (i.e. the lock 400 is in its locking condition). However, the dimensions of the cylinder plug 430 are such that the movable member 3 locates in the first rebate 484 only in the event that the movable member 3 is in its position to the right as shown in FIG. 6b (i.e. the lock 400 is in its unlocking condition). Conversely, in the event that the movable member 3 is in its position to the left as shown in FIG. 6a (i.e. the lock 400 is in its locking condition), the movable member 3 does not locate in the first rebate 484.

The lock 400 operates as follows.

In the event that no electric current flows through the coils 9 and 11, the movable member 3 is disposed towards the left as shown in FIG. 6a, such that the end of the movable member 3 having the south pole 6 is disposed in the second rebate 482 of the cylinder plug 430, and the end of the movable member 3 having the north pole 5 is not disposed in the first rebate 484. In view of this, in the event that a user rotates the turn knob 470, the rotational movement is not transferred to either the cylinder plug 430 or the latch bar 480, and the external mechanism (not shown) attached to the latch bar 480 is not operated. In this way, in the event that no electric current flows through the coils 9 and 11, the lock 400 remains in its locking condition.

In the event that electric current flows through the coils 9 and 11, the movable member 3 moves to the right, such that the end of the movable member 3 having the south pole 6 is disposed in the second rebate 482 of the cylinder plug 430, and the end of the movable member 3 having the north pole 5 is disposed in the first rebate 484. In view of this, in the event that a user rotates the turn knob 470, the rotational movement is transferred to the cylinder plug 430 and hence the latch bar 480, and the external mechanism (not shown) attached to the latch bar 480 is operated. In this way, in the event that electric current flows through the coils 9 and 11, the lock is in its unlocking condition.

The lock 400 further includes a processor (not shown), which is able to selectively control the flow of electric current through the coils 9 and 11. For example, the lock 400 further includes a plurality of numbered buttons disposed on the turn knob 470, such that in the event that a user inputs a correct combination of numbers, the processor initiates the flow of electric current.

Referring to FIG. 7, a solenoid assembly 501 has a first electro-magnet means in the form of electro-magnetic coil 509 for producing a first magnetic field in response to an electric current. The assembly also has a movable element, in the form of permanent magnet 503 that is disposed at least partially within the first magnetic field. The permanent magnet 503 moves within the first magnetic field in response to electric current flowing through said first electro-magnet means that creates the magnetic field.

The solenoid assembly 501 acts in use as follows. When an electric current flows through the coil 509 the magnetic field produced acts on permanent magnet 504 causing one of the north pole 505 or south pole 506 to be attracted towards or repelled from the coil 509. If the direction of the current is changed the magnet 504 will move in the opposite direction.

Referring to FIG. 8, a solenoid assembly 601 has a first electro-magnet means, in the form of first magnetic coil 609, for producing a first magnetic field in response to an electric current. The assembly also has a second electro-magnet means, in the form of second magnetic coil 611, for producing a second magnetic field in response to an electric current. The assembly further has at least one movable member, in the form of a ferrous rod 603, disposed adjacent, and preferably within, the first and second coils, 609 and 611, for movement in response to electric current flowing through the first and/or second coil. The first and second coils are arranged so that the forces resulting from the first and second magnetic fields they produce are directed in substantially opposite directions. That is to say that the first and second magnetic fields act in substantially opposite directions. This is achieved by the coils being wound in opposite directions.

The solenoid assembly 601 acts in use as follows, when an electric current flows through the first coil 609 the rod 603 moves towards the first coil. If the first coil is turned off and current flows through the second coil 611 the rod moves towards the second coil.

With reference to FIG. 9, a solenoid assembly is represented generally by reference numeral 701. The solenoid assembly 701 is similar to that shown in FIG. 1 and comprises a movable element 703 comprising a permanent magnet 704 having a north pole 705 and a south pole 706, along with a first ferrous flux guide 707 attached to the north pole 705 of the permanent magnet 704 and a second ferrous flux guide 708 attached to the south pole 706 of the permanent magnet 704. The movable member 703 further comprises a non magnetic retainer 722 disposed around the permanent magnet 704 to assist in maintaining the constituent parts of the movable member 703 in their correct configuration. The retainer also assists in maintaining the movable member in a substantially centralized position within the first 709 and second 711 electrically conductive coils.

The solenoid assembly 701 further comprises first electrically conductive coils 709 having a first end 709a and a second end 709b, and second electrically conductive coils 711 having a first end 711a and a second end 711b. The first and second coils 709 and 711 are arranged with the windings of their respective coils in opposite directions. In other words, the first coil 709 is wound in an anticlockwise direction and the second coil 711 is wound in a clockwise direction.

The solenoid assembly 701 further comprises third electrically conductive coils 712 having a first end 712a and a second end 712b, and fourth electrically conductive coils 714 having a first end 714a and a second end 714b. The third electrically conductive coil 712 is arranged with its windings in a clockwise direction, and the fourth electrically conductive coil 714 is arranged with its windings in an anticlockwise direction. Moreover, the number of turns on the first 709 coils is substantially equal to the number of turns on the second coils 711. Further, the number of turns on the third coils 712 is substantially equal to the number of turns on the fourth coils 714. It is however to be appreciated that the number of turns on the coils 709 and 711 may be either equal to or different from the number of turns on the coils 712 and 714.

As can be clearly seen from FIG. 9, the third electrically conductive coil 712 is arranged to the left of the first electrically conductive coil 709, with its end 712b adjacent end 709a, and the fourth electrically conductive coil 714 is arranged to the right of the second electrically conductive coil 711, with its end 714a adjacent end 711b.

As can be also be clearly seen from FIG. 9, the longitudinal axis A passes through the centre of both the first coil 709, the second coil 711, the third coil 712 and the fourth coil 714. In this way, the first 709, second 711, third 712 and fourth 714 coils are aligned with each other and are disposed end to end.

The solenoid assembly 1 further comprises a ferrous shell 713 disposed radially outwardly of the coils 709, 711, 712 and 714.

As with the embodiment of FIG. 1, the flux guides 707 and 708 provide a flux permeable path offering low resistance to the magnetic field, which provides a means for minimizing the length of the air gaps through which the magnetic flux must pass. By using the flux guides 707 and 708, the length of the air gap is the radial distance from the outside surface of the flux guides 707 and 708 to the inside surface of the ferrous shell 713.

The solenoid assembly 701 further comprises a first ferrous stop 716 disposed on the left of the assembly as shown in FIG. 9 and adjacent the first end 712a of the third electrically conductive coil 712. There is additionally provided a second ferrous stop 718 disposed on the right of the assembly as shown in FIG. 9 and adjacent the second end 714b of the fourth electrically conductive coil 714. It can be clearly seen that in FIG. 9, the flux guide 707 is engaged with the first ferrous stop 716.

The movable element 703 is disposed such that it is free to move in a direction through the first 709 and second 711 electrically conductive coils, but as can be clearly seen from FIG. 9, the presence of the first 716 and second 718 ferrous stops means that the movable member 703 cannot move longitudinally to such an extent that it passes through the centre of the third 712 and fourth 714 coils. To elaborate, the movable member 703 cannot move to such an extent that any part of it overlaps with either the third 712 or the fourth 714 coils.

It is to be appreciated that the movable element 703 is able to move either in a direction from the first end 709a of the first electrically conductive coil 709 to the second end 711b of the second electrically conductive coil 711, or in an opposite direction from the second end 711b of the second electrically conductive coil 711 to the first end 709a of the first electrically conductive coil 709, depending upon the direction of flow of electric current through the coils 709 and 711. It is to be appreciated that the coils 709, 711, 712 and 714 may be connected either in series or in parallel.

The solenoid assembly 701 further comprises a first push and pull rod 715, which is disposed at one end of the movable element 703, adjacent the north pole 705. There is additionally provided a second push and pull rod 720, which is disposed at an opposite end of the movable element 703, adjacent the south pole 706. The first 716 and second 718 ferrous stops each include an aperture 716a and 718a respectively, through which the first 715 and second 720 push and pull rods respectively can pass. In this way, the first 715 and second 720 rods protrude through the ferrous stops 716 and 718 respectively.

The solenoid assembly 701 operates as follows. A magnetic field is established by the permanent magnet 704, and the resulting lines of magnetic flux flow in complete paths through the permanent magnet 704, the flux guides 707 and 708, the coils 709, 711, 712 and 714, and the ferrous shell 713.

In the event that no electrical current flows through any of the electrically conductive coils 709, 711, 712 and 714, the movable member 703 remains at rest and magnetically coupled to either the first ferrous stop 716 or the second ferrous stop 718. Assuming that the movable member 703 is initially at rest adjacent the first ferrous stop 716 as shown in FIG. 9, the first 709, second 711 and third 712 coils are then energized so that electric current flows therethrough. As a result of the electric current flowing through the third electrically conductive coil 712, magnetic flux is generated that is which is in an opposite direction to that generated as a result of the permanent magnet 704. In this way, the magnetic field which holds the movable member 703 against the first ferrous stop 716 is caused to collapse, with the result that the movable member 703 is no longer magnetically coupled to the first ferrous stop 716. In view of this, the electric current flowing through the first 709 and second 711 coils causes the movable member 703 to move to the right, that is, in a direction from the first coils 709 towards the second coils 711. In the event that the movable member has moved a certain distance to the right, for example half way through the space within the first 709 and second 711 coils, then a controller (not shown) switches the electric current off in the first 709, second 711 and third 712 coils. Despite this, the magnetic attraction between the movable member 703 and the second ferrous stop 718 results in the movable member still moving to the right, until it reaches the second ferrous stop 718 whereby it comes to rest and is magnetically coupled to the second ferrous stop 718.

In the event that it is required to reverse the operation, then the controller energises the first 709, second 711 and fourth 714 coils. In a similar fashion to that described above, as a result of the electric current flowing through the fourth electrically conductive coil 714, the movable member 703 is no longer magnetically coupled to the second ferrous stop 718 and so the electric current flowing through the first 709 and second 711 coils causes the movable member 703 to move to the left, that is, in a direction from the second coils 711 towards the first coils 709. In the event that the movable member has moved a certain distance to the left, for example half way through the space within the first 709 and second 711 coils, then the controller switches off the electric current in the first 709, second 711 and fourth 714 coils. Despite this, the magnetic attraction between the movable member 703 and the first ferrous stop 716 results in the movable member still moving to the left, until it reaches the first ferrous stop 716 whereby it comes to rest and is magnetically coupled to the first ferrous stop 716.

In view of the fact that the direction of flow of the electric current through the first coils 709 is anticlockwise and that the flow of electric current through the second coils 711 is clockwise, the forces applied to the movable member 703 by the magnetic fields generated by the coils 709 and 711 are additive. Moreover, the direction of the force applied to the movable member 703 as a result of the interaction of the magnetic fields is substantially parallel to the longitudinal axis A.

The push and pull rods 715 and 720 may each be connected to an external device and facilitates the function of the solenoid assembly 701 as either a push actuator or a pull actuator depending upon which coils are energized by the controller. As with the embodiment of FIG. 1, the push and pull rods 715 and 720 are preferably made from a non magnetic material.

The magnitude of the force exerted on the movable element 703 is dependent upon, and is directly proportional to, the strength of the magnetic field in the coils 709 and 711 as a result of the permanent magnet 704 and the electric current flowing through the coils 709 and 711. The magnetic flux density in the coils 709 and 711 as a result of the permanent magnet 704 is a constant for all positions of the movable element 703 within the coils 709 and 711. Accordingly, for constant electric current flowing through the coils 709 and 711, the force exerted on the movable element 703 is constant over the allowable movement of the movable element 703.

Appendix A provides a set of calculations relating to the functionality of the solenoid assemblies as described above.

It is to be appreciated that the solenoid assemblies as described above are particularly suitable for use in the field of biomechanics. Most artificial limbs use motors and gearboxes, which can be expensive, heavy and bulky. They also generate a significant amount of noise, which is required to be dampened. The solenoid assembly as described above would have numerous applications in the field of artificial limbs since it generates less noise and facilitates faster movement, when compared to known mechanisms.

Moreover, the solenoid assembly as described above has applications in portable ventilators as used by ambulance crews. Typically, portable ventilators use a balloon type mask whereby the operator squeezes the bag to urge air into the lungs of the patient when required. This procedure requires the skill, training and judgement of the operator, who has to stand over the patient and actively squeeze the bag at the correct frequency. A portable ventilator incorporating a solenoid assembly as described above would obviate the requirement for judgement on behalf if the operator, and would also not require the operator to stand over the patient in order to operate the portable ventilator, thereby allowing them to do other tasks.

Further, the solenoid assembly as described above can be used in order to assist in the application of pressure to a wound. Typically, in the event that a tube has been inserted into the femoral artery during a medical procedure, the patient has a compression bandage applied to the site of insertion, which is adjusted every few minutes for example, by a nurse. A device incorporating a solenoid assembly as described above could facilitate the necessary pressure changes and would thereby obviate the need for the regular manual adjustment of the pressure.

As well as the applications discussed above, the solenoid assembly as described above would have applications in the field of heart assist devices and replacement hearts.

Moreover, the solenoid assembly as described above can be incorporated into medical equipment that uses lenses which require some means of adjusting the focus when required. Such focusing is typically achieved by means of a conventional motor and a screw thread. However, the solenoid assembly could instead be used to provide a quicker response and could be used in conjunction with a distance sensor for example, to ensure that a given instrument is maintained at a predetermined distance away from an object, which could have applications in X ray equipment, for example.

It will be appreciated by persons skilled in the art that the above embodiments have been described by way of example only, and not in any limitative sense, and that various alterations and modifications are possible without departing from the scope of the invention as defined by the appended claims.

### APPENDIX A

### 1.0) Requirements and Existing Solenoid Parameters

| | |
|---|---|
| Pull/Push force | 6 Newtons = 1.35 lbs = 614 gm |
| Holding force | 20 Newtons = 4.50 lbs = 2048 gm |
| Drive voltage | 14 VDC |
| Winding resistance | 9.1 ohms |
| Current = 14 VDC/9.1 ohm = 1.54 | |
| amperes | |
| Dimensions: | W = 29 mm = .787 inch |
| | H = 16 mm = .630 inch |
| | L = 42 mm = 1.650 inch |

### 2.0) Basic Calculations

The comments and discussion in this section are intended to allow the solenoid to be sized and to lead to an understanding of where the trade offs and problems will be.

### 2.1) Latching Force

I tested a 0.375 inch diameter Neodymium magnet to see how much weight it could lift and determined that it could just lift 5 lbs. This means that the minimum diameter for the magnet is 0.375 inches.

The cross sectional area of the magnet would then be A=pi*d̂2/4=pi*0.375*375/4=0.110 sq.in.

### 2.2) Shell Diameter

As a first approximation we will make the OD of the shell 0.750 inch. This will be adjusted as required as the design develops.

Note that the flux density that will be present in the shell will be much less than the saturation flux density of the shell material. Because of this, it is not a necessity for the shell cross section to be equal to the magnet cross section but, we will start off with this value.

An exact calculation is not required but is performed anyway.

OD area=pi*OD̂2/4

ID area=pi*ID̂2/4

A=OD area−ID area=pi*OD̂2/4−pi*ID̂2/4=pi*(OD̂2−ID̂2)/4=0.110 sq.in.

OD̂2−ID̂2=0.110*4/pi

ID̂2=OD̂2−(0.110*4/pi)=0.5625−0.140=0.4224

ID=SQR(0.4224)=0.650

Shell thickness=(OD−ID)/2=(0.750−0.650)/2=0.100/2=0.050

Experience tells us that the flux density in the shell will not be more than about half of the saturation level so, we could reduce the shell thickness to about 0.025 inches. I will use this number for now. This will make the shell ID=0.700 inch.

### 2.3) Radial Flux Path

For this design, I will make the diameter of the flux guide larger than the diameter of the magnet by about 0.150 inch. This will result in a radial flange that is 0.075 inch wide. This is sufficient to permit threading the minor diameter. By doing this we can also thread the ID of the retainer and the entire armature assembly can be screwed together.

The major OD of the flux guide will then be 0.375+0.150=0.525 inch.

The radial distance from the surface of the flux guide to the ID of the shell will be (0.700−0.525)/2=0.0875.

If the bobbin wall is 0.0175 inch thick then the radial space available for the winding will only be 0.070 inch. This is probably not enough room for the winding that we will need.

I will reduce the magnet diameter to 5/16 inch=0.3125 inch. If we make the major diameter of the flux guide 0.150 inch larger then it will be 0.150+0.3125=0.4625 inches in diameter. Under this condition the radial distance between the surface of flux guide and the ID of the shell will be as follows.

radial length=(0.700−0.4625)/2=0.119 inch

The total length that a line of flux must travel is twice the radial length=2*0.119=approximately 0.240 inch.

If the bobbin wall thickness is 0.019 inch then the radial dimension of the winding window will be 0.100 inch.

### 2.4) Magnetic Properties

Coercive force=11,000 Oersteds=22,220 ampere*turns/inch

Residual flux density=13,500 Gauss=1.35 Webers=1.35 E+8 Maxwells/sq.m=87,000 Maxwells/sq.in.

As a minimum the length of the magnet should be long enough so that it is shorter for a line of flux to travel to the shell then, along the shell and then back across the radial air gap to the other end of the magnet than it would be to travel directly by air from one end of the magnet to the other. If we make the magnet 0.500 inch long then it is more than twice as long as the sum of two radial air gaps. This will be the starting length.

The cross sectional area of the 5/16″ magnet is a=pi*d̂2/4=pi*0.3125*0.3125/4=0.0767 sq.in.

The maximum flux available from the magnet is B*A=87,000*0.0767=6673 Maxwells.

The maximum mmf from the magnet is H*length=22,220 NI/inch*0.5 inch=11,110 ampere*turns.

### 2.5) Flux Guide

For this discussion we will make the length of the cylindrical surface of the flux guide 0.120 inch. We will make the length of the smaller diameter section 0.120 inch as well. This would allow at least 2 complete threads of engagement of a standard 5/16-18 thread. Note that the major diameter is 0.3125+0.150=0.4624

### 2.6) Air Gap Permeance

The air gap can be divided into three standard sections from Roters book. These are sections 15, 17 and 19a.

### 2.6.1) Section 15

r1=0.4625/2=0.231

g=0.119

l=0.120

u=3.2

x=ln((r1+g)/r1)=0.415

P15=(2*pi*u*l)/x=5.8 Maxwells/NI

### 2.6.2) Section 17

P17=3.3*u(r1+0.575*g)=3.16 Maxwells/NI

### 2.6.3) Section 19a

x=ln((r1+g)/g)=1.08

P19a=4*u(r1+g−SQR(g(r1+g)))*x=2.0 Maxwells/NI

### 2.3.4 Total Permeance

Ptotal=P15+P17+P19a=11 Maxwells/NI for each air gap. There are two air gaps and they are in series so the total permeance will be cut in half to 5.5 Maxwells/NI

### 2.7) Magnetic Operating Point

The operating point can be found by the solution to two simultaneous linear equations.

The equation for the magnet is as follows. It is a straight line passing through the two points (x, y) that are

(0, 6667) and (−11,110, 0)

The equation for the magnet has a positive slope and is of the following form.

y=a*x+b

We know that when x=0, Y=6667 so substitute these values into the primitive equation.

6667=a*0+b=b

So, b=6667.
We also know that when y=0, x=−11,110. So, do the substitution and find a.

0=a(−11,110)+6667

11,110*a=6667

a=6667/11,110=0.6

The equation of the magnet is now known and is as follows.

y=0.6*x+6667

The equation for the air gap has a negative slope of −P and intersects the origin.

y=a*x+b

When x=0, y=0 so, b must also =0

The equation of the air gap is y=−a*x Where a=−P

y=−P*x=−5.5x

Solve the equations simultaneously by substitution to find the operating point.

y=−5.5x=0.6x+6667

−5.5x−6x=6667

−11.5x=6667

x=6667/−11.5=−580 ampere*turns

y=0.6(−580)+6667=6319 Maxwells

### 2.8) Flux Density in Sections 15, 17 and 19a

P15=5.8

P17=3.16

P19a=2.0

Ptotal=11.0

The flux that will flow through each of the sections is as follows.

flux15=6319*P15/Ptotal=3332 Maxwells

flux17=6319*P17/Ptotal=1815

flux 19a=6319*P19a/Ptotal=1148

### 2.8.1) Mean Flux Density and Force Per Ampere*Turn Through P15

The mean cross sectional area of P15 is taken at the half way point along the radial flux path. The mean diameter at that point is (OD of flux guide+ID of shell)/2=(0.4625+0.700)/2=0.581 inch. The circumference at the mean diameter is pi*0.581=1.826 inch. Since the width of the cylindrical surface of the flux guide is 0.120 inch, the mean cross sectional area of the P15 path is 0.120*1.826=0.219 sq.in.

P15 is carrying 3332 Maxwells through 0.219 sq.in. so, the flux density in P15 is 3332/0.219=15,206 Maxwells/sq.in.

The force equation is as follows.

F=8.86E−5I*B*L

Where:
F=lbs
I=amperes
B=kilo-maxwells/sq.in.=15.2
L=length of conductor in the field

L=N*mean length of a single turn

mean length of a single turn=1.826 inch from the above as a reasonable approximation.

If we let I=1 ampere and N=1 turn then the calculated force will be for a single ampere*turn and we can scale it later.

F per ampere*turn=8.86 E−5*1*15.2*1.826=0.0246 lbs/NI=11.1 gm/NI

### 2.8.2) Mean Flux Density and Force Per Ampere*Turn Through P17

P17 has the same mean diameter as P15 and it has the same mean length per turn on the coil. The main difference is that p17 is the same width as the radial air gap of 0.231 inch instead of 0.120 inch for P15. The mean cross sectional area of P17 then becomes 0.231*1.826=0.422 sq.in. With only 1815 Maxwells flowing through P17 the flux density will be 4303 Maxwells/sq.in. Because this is only about ⅓ of the flux density in P15, the force per ampere*turn will be about ⅓rd as much or about 3.6 gms/NI. However, because it is twice as wide as P15 it will affect twice as many turns as the flux flowing in P15.

### 2.8.3) Mean Net Force Per Ampere Turn

We can ignore the force resulting from P19a and let it be margin.

We want to simplify the problem for future calculations. The method of doing this is to, in the future, only consider the turns that are coupled by P15. We know that the force generated by those turns will be 11.1 gm/NI. But, in addition to this force, P17 will generate 3.6 gm/NI for all the turns that span a length of coil that is twice as long as the section of coil coupled by P15 alone. This means that we will enjoy an additional 7.2 gms of force. The sum will be approximately 18 gms/NI. If we just count the turns that are coupled by P15 and multiply that number by 18 gms/NI we should be able to predict the total force.

### 2.9) Coil Calculation

The existing solenoid operates from 14 volts and has a winding resistance of 9.1 ohms. This gives a coil current of 1.54 amperes.

The required pull force is 619 gms. In order to obtain this we must have 619/18=34.4 ampere*turns coupled by P15. Since we can have as much as 1.54 amperes, we will need only 22.3 turns coupled by P15.

The winding window is 0.120*0.231=0.0277 sq.in.

Divide this by 22 to get 0.00126 which is the cross sectional area allowed per turn in the winding window. Consider this area to be a square cross section. Take the square root to determine the length of a side of the square which will also be the diameter of the wire that we can use and we get 0.0355 inch. This is a very large wire!

1. A solenoid assembly comprising: —
(i) at least one first electro-magnet device for producing a first magnetic field in response to an electric current; and
(ii) at least one movable element disposed adjacent at least one said first electro-magnet device for movement in response to electric current flowing through at least one said first electro-magnet device,
wherein at least one said movable element comprises at least one permanent magnet.

2. A solenoid assembly as claimed by claim 1, wherein at least one said first electro-magnet device comprises at least one first electrically conductive coil having a first end and a second end.

3. A solenoid assembly as claimed by claim 1, wherein at least one said movable element further comprises at least one first flux guide disposed adjacent a first end of said permanent magnet and at least one second flux guide disposed adjacent a second end of said permanent magnet.

4. A solenoid assembly as claimed by claim 1, further comprising a further movable element disposed end to end with said movable element.

5. A solenoid assembly as claimed by claim 1, further comprising a ferrous shell disposed radially outwardly of, and at least partially overlapping with, at least one said first electrically conductive coil.

6. A solenoid assembly as claimed in claim 1, further comprising at least one second electro-magnet means device for producing a second magnetic field in response to an electric current.

7. A solenoid assembly as claimed in claim 6, wherein at least one said second electro-magnet device comprises at least one second electrically conductive coil having a first end and a second end, whereby said first end of at least one said second electrically conductive coil is disposed adjacent the second end of at least one said first electrically conductive coil, wherein said movable element is movable through said electrically conductive coils in a direction between said first end of at least one said first electrically conductive coil and said second end of at least one said second electrically conductive coil in the event that electric current flows through at least one of said first and second electrically conductive coils.

8. A solenoid assembly as claimed in claim 7, wherein said coils are disposed such that electric current is able to flow in one of a clockwise or anticlockwise direction through at least one said first electrically conductive coil, and in the other of a clockwise or anticlockwise direction through at least one said second electrically conductive coil.

9. A solenoid assembly as claimed in claim 7, wherein at least one said second electrically conductive coil is electrically connected to at least one said first electrically conductive coil.

10. A solenoid assembly as claimed in claim 1, wherein said permanent magnet comprises a mild steel elongate element.

11. A solenoid assembly as claimed in claim 7, further comprising a ferrous shell disposed radially outwardly of, and at least partially overlapping with, said first and second electrically conductive coils.

12. A solenoid assembly as claimed in claim 7, further comprising at least one third electrically conductive coil disposed adjacent said first end of said at least one first electrically conductive coil, and at least one fourth electrically conductive coil disposed adjacent said second end of said at least one second electrically conductive coil.

13. A solenoid assembly as claimed in claim 12, wherein at least one first, second, third and fourth electrically conductive coils are arranged so that electric current flows through at least one said third electrically conductive coil in an opposite sense to said at least one first electrically conductive coil, and so that electric current flows through at least one said fourth electrically conductive coil in an opposite sense to at least one said second electrically conductive coil.

14. A solenoid assembly as claimed in claim 12, further comprising a first ferrous stop adjacent at least one said third electrically conductive coil, and a second ferrous stop adjacent at least one said fourth electrically conductive coil.

15. A solenoid assembly comprising: —
(i) at least one first electro-magnet device for producing a first magnetic field in response to an electric current;
(ii) at least one second electro-magnet device for producing a second magnetic field in response to an electric current;
(iii) at least one movable member disposed adjacent at least one said first and at least one second electro-magnet devices for movement in response to electric current flowing through said first and/or second electro-magnet device wherein at least one said first and second electro-magnet device are disposed such that the first and second magnetic fields act in substantially opposite directions.

16. A solenoid assembly as claimed in claim 15, wherein at least one said first electro-magnet device comprises at least one first electrically conductive coil having a first end and a second end, and at least one said second electro-magnet device comprises at least one second electrically conductive coil having a first end and a second end.

17. A solenoid assembly as claimed in claim 16, wherein at least one said first and second electrically conductive coils are arranged such that the first end of at least one said second electrically conductive coil is disposed adjacent the second end of at least one said first electrically conductive coil.

18. A solenoid assembly as claimed in claim 16, wherein at least one said first and second electrically conductive coils are arranged such that electric current flows in one of a clockwise or anticlockwise direction through at least one said first electrically conductive coil and in the other of a clockwise or anticlockwise direction through at least one said second electrically conductive coil.

19. A solenoid assembly as claimed in claim 16, further comprising at least one third electrically conductive coil disposed adjacent said first end of said at least one first electrically conductive coil, and at least one fourth electrically conductive coil disposed adjacent said second end of said at least one second electrically conductive coil.

20. A solenoid assembly as claimed in claim 19, wherein at least one first, second, third and fourth electrically conductive coils are arranged so that electric current flows through at least one said third electrically conductive coil in an opposite sense to said at least one first electrically conductive coil, and so that electric current flows through at least one said fourth electrically conductive coil in an opposite sense to at least one said second electrically conductive coil.

21. A solenoid assembly as claimed in claim 19, further comprising a first ferrous stop adjacent at least one said third electrically conductive coil and a second ferrous stop adjacent at least one said fourth electrically conductive coil.

22. A solenoid assembly comprising: —
(i) at least one first electrically conductive coil for producing a first magnetic field, wherein at least one said first electrically conductive coil is disposed such that electric current flows therethrough in first sense;
(ii) at least one second electrically conductive coil for producing a second magnetic field wherein at least one said second electrically conductive coil is disposed such that electric current flows therethrough in a second sense opposite said first sense; and
(iii) at least one movable member disposed adjacent said first and second coils.

23. A lock comprising a solenoid assembly as claimed in claim 1.

24. (canceled)

25. (canceled)
